(19) United States
(12) Patent Application Publication
(10) Pub. No.: US 2017/0161851 A1
(43) Pub. Date: Jun. 8, 2017

(54) Restaurant Notification System

(71) Applicant: Toast, Inc., Boston, MA (US)

(72) Inventors: Hao Chen Li, Cambridge, MA (US); Yi Chen, Boston, MA (US); Samuel Ka Yin Leung, Cambridge, MA (US); Timothy Fredette, Carlisle, MA (US); Steve Fredette, Wayland, MA (US)

(21) Appl. No.: 15/373,328

(22) Filed: Dec. 8, 2016

Related U.S. Application Data
(60) Provisional application No. 62/264,655, filed on Dec. 8, 2015.

(51) Int. Cl. G06Q 50/12; H04B 1/3827; H04W 4/14

(52) U.S. Cl. CPC G06Q 50/12; H04W 4/14; H04B 1/385

(57) ABSTRACT

A restaurant management system is disclosed, comprising: a management tablet computer for receiving touch-based user input; a coordinating server for receiving an instruction from the management console and for sending a message with destination information based on the instructions; a message queueing server, for receiving the message from the coordinating server, evaluating the destination information of the message, and forwarding the message to at least one destination, the message queueing server further comprising a plurality of messaging queues; and a smartwatch for receiving the message from the message queueing server, the smartwatch corresponding to the destination information of the received messages.

### CROSS REFERENCE TO RELATED APPLICATIONS

This application claims the benefit of priority under 35 U.S.C. §119(e) of U.S. Provisional Patent Application No. 62/264,655, filed on Dec. 8, 2015 and entitled “Restaurant Notification System,” which is hereby incorporated by reference herein in its entirety for all purposes.

### BACKGROUND

The restaurant industry provides a challenging environment, both for restaurant staff, who wants to provide the most efficient and effective service possible to their staff, and also for designers of restaurant technology to develop software and hardware systems that can effectively solve problems in a fast-paced environment. Recently, smart devices such as smartwatches have become more prevalent. Smartwatches have advantages over tablets for delivering notifications, as they are more likely to be physically touching a person, and less likely to be stored in a pocket, such that notification displays, vibrations, etc. may more readily be perceived by the individual. Smartwatches and other such devices also enable notifications to be delivered to a particular person without alerting other persons nearby, which can be useful in the context of providing a superior customer service experience to patrons of a restaurant. Systems and methods are disclosed herein to permit such devices to be used as part of an order-taking system in a restaurant.

In some embodiments, notifications may be delivered to a smartwatch. In some embodiments, an Android Wear API may be used to send notifications from a tablet running the Android operating system to a smartwatch running the Android Wear operating system.

### SUMMARY

Systems and methods relating to a restaurant notification system are disclosed. In one embodiment, a restaurant management system is disclosed, comprising: a management tablet computer for receiving touch-based user input; a coordinating server for receiving an instruction from the management console and for sending a message with destination information based on the instructions; a message queueing server, for receiving the message from the coordinating server, evaluating the destination information of the message, and forwarding the message to at least one destination, the message queueing server further comprising a plurality of messaging queues; and a smartwatch for receiving the message from the message queueing server, the smartwatch corresponding to the destination information of the received messages.

The management tablet computer may be an Android tablet, wherein the smartwatch may be an Android Wear smartwatch. The queueing server uses a queuing messaging protocol and wherein the coordinating server and the message queueing server are operated as a redundant web service. An Android tablet for receiving the message from the messaging queueing server, and a facilitation network for securely forwarding the message from the Android tablet to the smartwatch, may also be provided. The message may comprise one or more of: a notification message type; a restaurant identifier; a device identifier; human-readable text; a table number, a number of guests, allergy information, a diner special request, and information about a kitchen order. The message may comprise a restaurant identifier, the restaurant identifier also stored at the coordination server to authenticate and track services provided to a restaurant. The message may comprise a notification message type, the notification message type further comprising a food ordered message type, a food ready message type, a food ready for takeout/pickup message type, a food ready to be served message type, a table cleared message type, a table ready message type, a kitchen closing message type, a timer message type, an order changed message type, and an order canceled message type. The message may be configured to be dismissed, or snoozed for later action, or replied to on the smartwatch once delivered.

In another embodiment, a restaurant messaging method is disclosed, comprising: receiving a restaurant management request at a coordinating server from a restaurant management device; selecting a restaurant management function at the coordinating server based on the received restaurant management request; identifying, at the coordinating server based on the selected restaurant management function, a targeted device to receive a notification; and sending a notification message to a queueing server with a queue identifier based on the targeted device, to be delivered to the targeted device.

A plurality of restaurant management requests may be received from a plurality of devices. The targeted device may be a wearable device or mobile device linked to an individual. The targeted device may be a smartwatch with the Android Wear operating system. The targeted device may be linked to an individual based on a prior-received mapping of individuals to either customer orders or customer restaurant tables. The method may further comprise receiving, at the queueing server, the notification message with the queue identifier at the queueing server; assigning, at the queueing server, the notification message to at least one message queue at the queueing server, the at least one message queue corresponding to the targeted device; and sending, from the queueing server, the queued message to the targeted device. The method may further comprise using a facilitation network for securely forwarding the notification message to the targeted device.

The notification message may comprise one or more of: a notification message type; a restaurant identifier; a device identifier; human-readable text; a table number, a number of guests, allergy information, a diner special request, and information about a kitchen order, the restaurant identifier also stored at the coordination server to authenticate and track services provided to a restaurant. The targeted device may be a mobile phone being targeted via a short message system (SMS) gateway. The notification message may comprise a notification message type, the notification message type further comprising a food ordered message type, a food ready message type, a food ready for takeout/pickup message type, a food ready to be served message type, a table cleared message type, a table ready message type, a kitchen closing message type, a timer message type, an order changed message type, and an order canceled message type. The notification message may be configured to be dismissed, or snoozed for later action, or replied to on the smartwatch once delivered.

### BRIEF DESCRIPTION OF DRAWINGS

FIG. 1 is a schematic diagram of a notification system, in accordance with some embodiments.

FIG. 2 is a flowchart of a notification method, in accordance with some embodiments.

### DETAILED DESCRIPTION

Smartwatches solve at least two problems with delivering notifications in a fast-paced restaurant environment. First, as described above, a smartwatch is more suitable for delivering notifications compared to a tablet because it is physically located on a user's body. Tablets used by restaurant staff tend to be placed in an apron pocket except when in active use, because wait staff are often carrying orders from the kitchen to the table, or performing other tasks that require both hands.

Second, a smartwatch is more suitable for delivering notifications compared to a tablet because it is often used by a single individual, not by multiple individuals. A tablet that is used for order taking may be shared among multiple staff members, especially if all tablets are equally able to submit orders to the kitchen. This phenomenon is observed at quick service restaurants, where the staff terminals require a user to sign in, but are frequently shared among multiple users even in spite of the sign in requirement. Because a smartwatch requires more effort to take off and transfer to another individual, it is more likely to be in use by the same individual, at least while on shift. This enables a software application to be designed to route notifications to that particular individual.

Third, a smartwatch is more suitable for delivering notifications compared to a tablet because it can act as a special-purpose device solely for use in delivering notifications in the context of the particular restaurant environment. A tablet is a general-purpose device, and receives many notifications that may not be desired in the restaurant environment, such as a battery charge notification, an app update notification, an email received notification, and the like. By contrast, a smartwatch can be configured to deliver only relevant notifications.

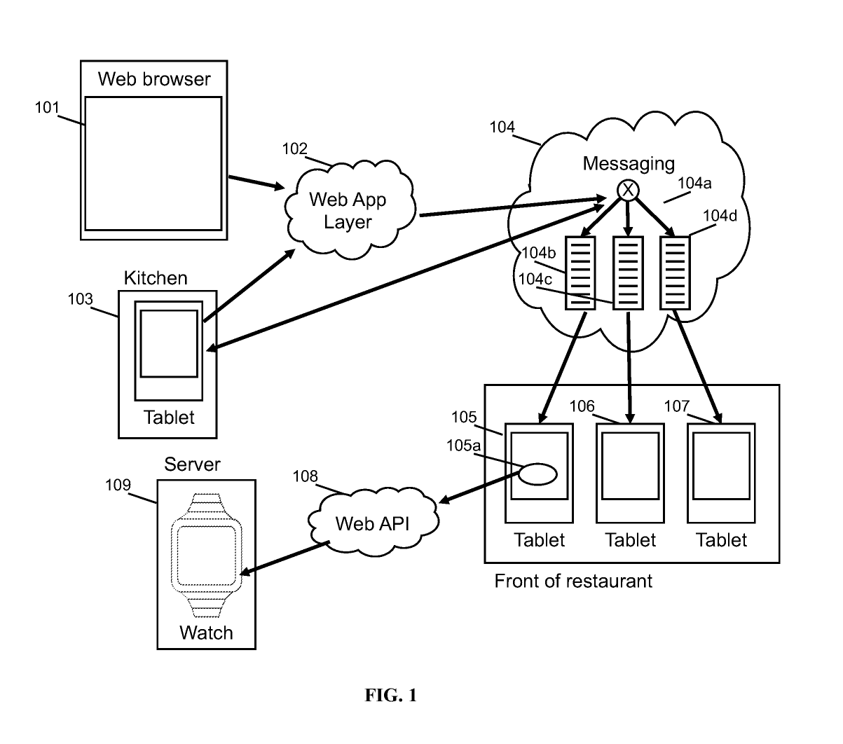

FIG. 1 depicts a browser 101, in communication with a web application layer/coordinating server 102, in accordance with some embodiments. The coordinating server may be located on the Internet or on an intranet, and is in communication with a kitchen device 103 and a messaging server 104. The messaging server 104 includes a dispatcher module 104a and several queues 104b, 104c, 104d. The messaging server is also in communication with kitchen device 103. The messaging server is also in communication with staff devices 105, 106, 107. Staff device 105 includes communications module 105a, which is in communication with a facilitation network 108, which is in communication with personal notification device 109.

In some embodiments, the system depicted in FIG. 1 may be configured to work with a Google Android operating system on one or more devices. Facilitation network 108 may be a Google web service providing notification services for an Android Wear device, or another Web API or notification service cloud service. In some embodiments, personal notification device 109 may be a watch or other wearable device, and may be running an Android Wear operating system. Communications module 105a may be an Android Wear API module running on device 105.

In operation, an order is placed at browser 101 by a user via an online ordering portal. Alternately, the order may be placed by a waiter taking an order from a person physically in a restaurant, using a browser or an application running on a mobile device, such as staff device 105. Alternatively, the staff device may be a restaurant management console, such as a specially configured computer, a computer accessing a particular web application, or a restaurant management application on a tablet such as an Android tablet. The staff device may be configured to communicate directly to the messaging server 104 without going through coordinating server 102. Alternately, the order may be placed by a user/diner via a mobile device application. The order is transmitted to the coordinating server 102, which may be an application running on a web server running Heroku, Amazon Web Services, or another web application server software platform. The coordinating server then interprets the order and sends an instruction to send an order creation message to messaging server 104. Coordinating server 102 may act to process orders from multiple sources, such as a public Web portal, an Android point-of-sale device, an app on a consumer device, etc., and may determine what messages (or equivalently, notifications) should be generated and where the messages should be sent. The generated messages are passed to messaging server 104.

Messaging server 104 may use a RabbitMQ queueing server or another queueing server, and may support one or more messaging or queueing protocols, such as the advanced messaging queueing protocol (AMQP). Coordinating server 102 is the order processing server, in some embodiments. It may accept requests from multiple sources: e.g., web, Android point-of-sale device, consumer app. It contains the business logic to process these requests and determines what messages should be generated and their recipients. Then the order processing server asks messaging server to deliver the messages to appropriate destinations.

All communication over the wire may be encrypted via transport layer security (TLS). Payment data to or from a customer, either via an inline signaling path or via a separate signaling path, may be encrypted. The payment data may be received through a mobile device, through the online ordering portal, through an authorization to use stored payment information for the customer, or via another means. The coordinating server may be used to process payment.

During or before the receipt of a customer order, a waiter or waitress may arrive at the restaurant and clock in, at which point he or she may receive a smartwatch that is linked in the system to him or her. Throughout his or her shift, the waiter or waitress is assigned particular tables, orders, or customers at the restaurant by the restaurant management system. To enable this the management system may send a message to coordinating server 102 to request creation of message queues for each waiter or waitress, and may respond to queries or messages from coordinating server 102 to identify, based on the associated staff person, which smartwatch should receive notifications for a particular customer or table. The coordinating server then sends a message to the messaging server for forwarding to the particular smartwatch.

Continuing on, messaging server 104 receives the message pertaining to the created order and is configured to assign the message to one or more queues 104b, 104c, 104d. The queues contain messages to be delivered. Dispatcher module 104a determines which queue is the appropriate queue, and assigns the message corresponding to the order to the appropriate queue. Appropriateness of the queue may depend on characteristics of the message. As in this example, if a message is an order of a food item for a customer, the food item must be prepared in the kitchen, and the dispatcher module may be configured to send food orders to the kitchen's queue. The queue can be reflected by different stations and depending on the items they could be routed to a single or multiple stations. There are also different levels that allows the message to travel from one station to another station depending on preparation sequence. The queue can be reflected by different stations and depending on the items they could be routed to a single or multiple stations. There are also different levels that allows the message to travel from one station to another station depending on preparation sequence.

Once a message is dispatched, the queue performs the functions needed to send the message to a target device. In this example, the food order is transmitted to the kitchen device 103. The kitchen device receives the message and displays a visible notification of the order, in some embodiments printing a physical order ticket and in other embodiments displaying the order on a display screen. A cook in the kitchen is thus enabled to view and prepare the order. In the meantime, the kitchen device displays an onscreen control that enables the cook to indicate that the food item has been prepared.

After the food item is prepared and the cook operates the kitchen device to indicate that the item has been prepared, the kitchen device sends a notification to the coordinating server 102, or in some embodiments directly to messaging server 104, to pass the “order ready” information along. Processing occurs at the coordinating server to send a message to instruct the messaging server to send a message to one or more waitstaff. The messaging server adds a message indicating that the order is ready to one or more queues of a device held by waitstaff, and these one or more queues send this message to the staff device or devices 105, 106, 107.

In some embodiments, the staff devices may be Android tablets, or other devices with wireless connectivity to the messaging server via a router within the restaurant. The staff devices may be carried by the staff, such as in an apron pocket, in some embodiments, or they may be located at a designated staff area of the restaurant. The staff devices may, in some embodiments, be configured for order taking, so that staff may input orders directly into the devices. The staff devices may make a sound or other perceptible notification once the order ready information message is received. In some embodiments, the staff devices may have a persistent connection with the messaging server for sending and receiving notifications.

The messaging server may support a queueing protocol that supports message orientation, queueing, routing, point-to-point routing, publish-and subscribe routing, reliability and security guarantees, such as the advanced message queueing protocol (AMPQ). The queueing protocol may be a binary protocol, like AMPQ, or a text-based protocol. The messaging server may receive and intermediate queueing messages from a variety of clients. The messages may encode order information, time information, a sender and a target queue. A message may be sent to more than one target queue by the messaging server. The messaging server may be a RabbitMQ messaging server.

Once the kitchen staff determine that the food order has been prepared and is ready for pickup, the kitchen device sends a message to the coordination server 102 to indicate that the order has been fulfilled by the kitchen. The coordination server 102 may then send a message to the messaging server to request pickup of the food item by a waiter. In some embodiments the kitchen device may send a message directly to the messaging server and not to the coordination server. In some embodiments the coordination server may be integrated into the messaging server, or vice versa.

In some embodiments, the staff device 105 may have a module for communicating with a personal notification device 109. In some embodiments, the module may be an Android Wear notification API, communicating with an Android Wear smartwatch via Google as the facilitation network 108. The facilitation network may receive a notification from the Android Wear API via a secure channel, and may send a notification to the personal notification device 109. In some embodiments, the facilitation network may provide an authentication and/or security function using keys or device identifier information. In some embodiments, the facilitation network may use a connection back to the staff device 105 to communicate with personal notification device 109; in other words, staff device 105 may communicate directly with personal notification device 109 via Bluetooth or Wi-Fi Direct, or via another wireless technology. In some embodiments, the staff device may communicate directly with the personal notification device without use of a facilitation network. In an alternate embodiment, the smartwatch may be an Apple Watch, and may be paired with an Apple iOS device such as an iPhone or iPad, and the facilitation network may be any mechanism for delivering an Internet Protocol push notification to an application on the iOS device. As an Apple Watch typically receives a set of notifications via an iOS device, push notifications to the iOS device can be caused to propagate to the watch in a similar way as using a facilitation network.

Messages may include one or more of the following information elements: a message type, such as “kitchen order ready”; a restaurant identifier; a device identifier; and optionally additional text, such as the table number, number of guests, allergy information, diner special requests, or information about the kitchen order. The restaurant identifier may be used at the messaging server 104 and/or the coordination server 102 to authenticate and/or provide tracking of services provided to the restaurant. The device identifier may be used to ensure that the message is sent to the right device, worn by the right person, for example, to the waitstaff who is taking care of table number 5. In some embodiments, the notification may include an image or animation or video.

Examples of messages may include, for example, a food ordered message, a message that an order of food is ready for a particular table, that a table has been cleared, that a table is ready for a customer to be seated, that the kitchen is closing, that a particular amount of time has elapsed for a particular table (enabling a waiter to check in at a table or reassure a diner that food is still on its way), that a message has been entered relating to a particular table or food order, an order changed message, an order canceled message, and so on.

In some embodiments, interactivity may be permitted at the personal notification device. For example, the notification may be dismissed, or requested to return at a later time (“snooze”), or a brief reply may be permitted to be sent to the kitchen, or the kitchen may be prompted to provide status on a particular table's order, or a check may be opened or closed for a particular table. Tracking of the interactive elements may also be performed. In some embodiments, interactivity may be enabled in the form of sending a message read notification back to the messaging server, which may enable other systems to deprioritize any copies of the already-read notification.

As another example, suppose Person A and Person B make plans to meet at a restaurant. Person A uses a desktop computer to connect to coordinating server 102 via a web application to place an order prior to arriving at the restaurant. Person B arrives at the restaurant and uses a tablet computer at the restaurant to connect to coordinating server 102 to place an order. Coordinating server 102 uses a user interface specific to the particular restaurant to ask which ingredients should be included in the orders, which is displayed via the web to Person A and via the tablet computer to Person B. Coordinating server 102 also performs order checkout and credit card processing for payment. Once payment is complete, coordinating server 102 displays a confirmation message to Person A and separately to Person B.

Once Person A completes his or her order, the order is transformed into a message. The message includes an order identifier, specific information about the order, i.e., “prepare Burrito for Person A,” and contains a routing identifier specific to the particular restaurant, and also contains a routing identifier that is used generically to route messages to queues in restaurant kitchens. The message is then sent to messaging server 104. Coordinating server 102 also creates a queue, thread, or other mechanism to wait for confirmation that Person A's burrito has been prepared by the restaurant kitchen.

Messaging server 104 receives the message from coordinating server 102, and identifies which queues match the routing information on the message. The routing information may be a routing key. The messaging server may identify which queues have keys that match the routing key. The messaging server may perform a fuzzy match, a regular expression match, an exact match, or any other type of match. More than one queue may have the same key, so a single routing key may match a plurality of queues. The keys may be namespaced, so that many restaurants may be supported by a single messaging system. Messaging server 104 then sends the message to all queues that match, e.g., all kitchen displays at the restaurant, to display Person A's order request in the kitchen and to alert kitchen staff to prepare the order. Messaging server 104 also sends Person B's order in a separate message to the same queues, so that both Person A's order and Person B's order are prepared.

Meanwhile, Person A and Person B have been seated together at the restaurant.

The kitchen displays are configured to permit interactivity back to coordinating server 102 to inform the coordinating server when the food has been prepared. Once coordinating server 102 is informed that the food orders have been completed, coordinating server 102 may use business logic to determine who should receive completion messages. Coordinating server 102 creates and sends these messages to messaging server 104, which matches the messages to and sends the messages to each message queue.

In this case, coordinating server 102 can elect to send completion messages to one or more of: the order pickup station at the restaurant; Person A's preregistered smartphone via text message; Person B's ordering tablet at his or her table; Person A and Person B's table, as identified by staff at the restaurant; and a smartwatch worn by Person A and Person B's server, who has identified him- or herself using a staff management system at the restaurant. Other message recipients are also contemplated. Person A and Person B's waiter or waitress then receives the message to deliver the food in a timely manner.

In some embodiments, a feature may be present which allows the restaurant system to communicate directly with the end customer. For example, if the customer leaves his or her phone number for notification, when the kitchen fulfills a ticket, not only can the waitstaff be notified to serve the food, but the customer could also get a text message that the order has just been fulfilled by the kitchen. This is done by processing, at the coordinating server, the kitchen's order fulfillment message; identifying the customer's mobile phone number as being associated with the order (or the table, which may be associated with the order); and using a Twilio messaging gateway or other messaging gateway to receive a request via Internet Protocol (IP) send a message out to designated phone numbers via short message service (SMS).

In an alternative embodiment, a customer waiting for a table may be notified that his or her table is ready. This is done by a restaurant staff member indicating that the table is ready on a restaurant management tablet; the coordinating server identifying the next customer to be seated at the table; and the coordinating server sending a message via an SMS gateway to the previously-received customer phone number.

In some embodiments, customers who have submitted their phone numbers may be notified via SMS when their order or food is ready from the kitchen, which is particularly helpful for takeout or pickup scenarios; the customer will be informed that the food is ready for pickup or takeout without requiring a staff member at the restaurant to initiate a call or other messaging contact. The coordinating server may receive the message from the kitchen that the food is ready and may determine whether to send a notification message to the customer, to staff at the front of the restaurant, to waitstaff, or any combination of the above.

Other short text messaging services, such as Facebook Messenger and Apple iMessage, could also be integrated in this manner. The queueing server could also be interposed in front of the SMS gateway server to deliver queued messages according to a queue routing match. In some embodiments, individual restaurant staff may be contacted via phone number via SMS, instead of or in conjunction with contacting staff via smartwatches. The coordinating server may have a list of individual restaurant staff, and may also have a mapping of the staff to smartwatches; in the case that a smartwatch is not associated with a particular individual, the coordinating server may offer as an option the ability to reach the individual via SMS or another mobile device, or may fall back to SMS or mobile device notification as backup modes.

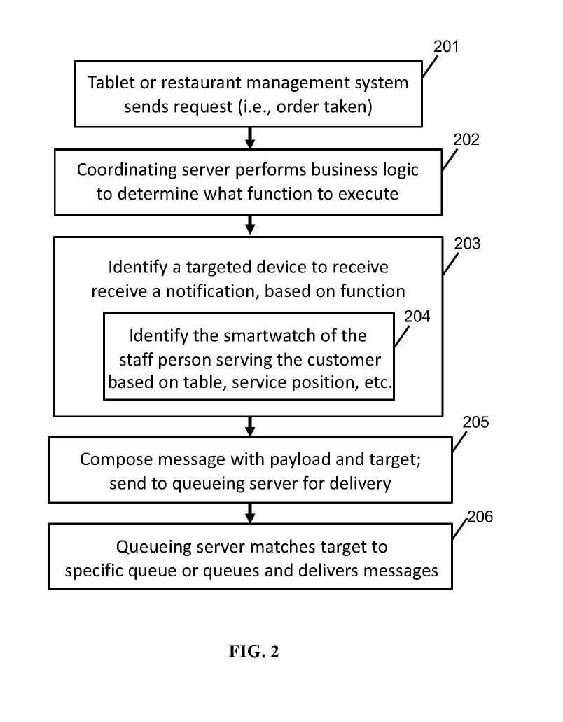

FIG. 2 is a flowchart of a notification method, in accordance with some embodiments. At step 201, a restaurant management system, such as a staff tablet or desktop with specially configured software in the restaurant, receives user input and sends a request based on that input to a coordinating server. The restaurant management system may be a web application accessed over the web by an end customer. The user input may be, for example, entry of a food order for a customer. The request is sent to the coordinating server.

At step 202, the coordinating server reviews the request. Based on the received request, the coordinating server may process the request in one or more ways. For example, food orders may be processed in one way, and food order completions may be processed in another way. As part of processing the request, the coordinating server may, at step 204, identify a device for delivering an effective notification. In FIG. 2, a smartwatch corresponding to the waiter or waitress serving the customer's table is identified based on a prior-received mapping of waiters and tables at the coordinating server. This allows a notification of food order completion to be sent to that waiter or waitress.

At step 205, the coordinating server completes the message with both a payload, i.e., the content required for the notification to be sent to the smartwatch, and a target, i.e., an identifier corresponding to the smartwatch. The message is completed and sent to the queueing server. In some embodiments, the target may be a person, which may be further disambiguated at the queueing server. At step 206, the queueing server matches the target identifier to one or more queues and delivers the messages in the queues. An example of a use case involving multiple queues is delivery of a customer order message to all kitchen displays.

Alternate embodiments may also be considered. For example, the system depicted in FIG. 1 may be configured to work with another operating system and operating environment, such as an Apple iOS-based environment, or a heterogeneous operating environment. Communications between the kitchen device 103 and messaging server 104, and between the messaging server and the staff devices, may be performed using a proprietary and/or cross-platform IP-based communications protocol.

Communications to the personal notification device may be performed directly over a local network or direct connection between the staff device and the personal notification device, including over Wi-Fi Direct, a local Wi-Fi network, a Bluetooth connection, or over another type of connection. One or more devices may use a cellular connection, such as a 2G, 3G, 4G, 5G, GPRS, UMTS, LTE, or LTE-A connection, or another type of connection. Communications may be transmitted over the public Internet, over a secure channel over the public Internet, or over a private network. A personal notification device may communicate over Bluetooth with a smartphone, which provides a connection to the Internet, and through the Internet to a messaging facilitation platform, such as Firebase Cloud Messaging, Google Cloud Messaging, Apple Push Notification Service, or another platform.

The personal notification device may be any smartwatch, including an Apple Watch, an Android Wear device, a Pebble, or another device. The personal notification device may be a non-watch device, such as a buzzer, a pager, a beeper, a bracelet, a ring, a smartphone, an earpiece, a device with a notification light, or a wearable device, such as rings, bracelets, collars, pendants, watch bands, chains, tags, garments, activity trackers, fitness trackers, glasses, headsets, headphones, and earphones. The notification may be a visual indication such as a light or a visible textual message, an audible indication such as a tone, a recorded sample, or a melody, a physically perceivable sensation such as a vibration, a tap, one or more vibrations or taps, a pattern of vibrations or taps, or another indication.

In some embodiments, a load balancer may act as a gateway between the remainder of the platform shown in FIG. 1 and the public Internet, in some embodiments. The load balancer also may allocate incoming requests among servers in a redundant app tier. In some embodiments, an HTTP load balancer such as nginx may be used.

In some embodiments, coordinating server 102 may be a group, or “tier,” of application servers that includes or more web servers for receiving web requests via Hypertext Transfer Protocol (HTTP), in some embodiments. The web servers may then determine what tasks, if any, need to be distributed to either a database tier or a queue tier. The web servers may then return fully- or partially-rendered web pages to a requesting web browser. As the web browsers may be behind a load balancer, different servers may service different web requests. In some embodiments, the web servers may be web application servers, and the applications running on them may be precompiled, linked at runtime, Common Gateway Interface (CGI) applications, modules executed by a web server process, or otherwise executed. The web servers may also integrate their own load balancing, in some embodiments. In some embodiments, load balancing may occur at various points in the system.

Additionally, in some embodiments, the messaging server 104 may include one or more servers as a tier, and may include a facility to activate or deactivate servers as needed to meet the needs of the service, in some embodiments. The queue tier may receive requests from an app tier and may identify sub-tasks, which may then be sent to a worker tier to be executed. The queue tier may use a queuing messaging protocol such as RabbitMQ, Qpid, ActiveMQ, or StormMQ for assigning tasks to processes at the worker tier, in some embodiments. The queue tier may use Celery, RQ, Taskmaster, or other queuing software with well-known queuing algorithms to provide reliable service.

In some embodiments, one or more of the servers described may operate using the Linux operating system, and/or using an Ubuntu distribution of Linux. Various messaging protocols may be used between tiers, including for message passing; for example, RabbitMQ and Celery queuing and message-passing middleware may be used. HTTP and JSON may be used as protocols for transmitting data. The web servers may use web applications written in Python in conjunction with a web server, such as Apache, Lighttpd, or Nginx. Caching may be performed at one of the app tier, queue tier, or database tier using a web cache or object cache such as MongoDB, CouchDB, or Redis. Servers as described herein may be virtual servers. Access to the platform may be partially limited to or solely through a virtual private network (VPN).

In some embodiments, a smartwatch or other device may perform initial handshaking to inform the messaging server that it is active and ready to receive messages. In some embodiments, a configuration screen may enable an administrator to assign particular staff devices to particular staff and/or particular tables, to assign particular orders or queues or messages to particular staff devices (including smartwatches), and so on, which may be understood to be a mapping of staff to devices. Registration, assignment, or mapping may be performed by restaurant staff via an interface that connects to the coordination server. In some embodiments, devices that are personally owned by the staff may be registered in the system for notification, in addition to restaurant-owned devices. In some embodiments, assignments of staff to devices may be performed without administrator involvement, based on the staff member clocking into work at the restaurant and/or physically putting on a notification device. In some embodiments, each single device may have its own dedicated queue at the messaging server. In some embodiments, multiple queues may be marked as joined or coupled together, e.g., so that a message intended for a particular staff member may be sent to more than one device. The coordination server may manage any staff to device mapping or queue coupling.

Further embodiments are described. In some embodiments, a single tablet may be used to cause messages to be sent to multiple smartwatches or personal notification devices. In some embodiments, one or more devices may have Wi-Fi, 802.11a/b/g/n/ac, Bluetooth, Wi-Fi Direct, 2G, 3G, 4G, 5G, GPRS, UMTS, LTE, or LTE-A, or other wireless networking technology.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smartphone or any other suitable portable or fixed electronic device.

A computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Modules may be statically or dynamically linked. Functional elements may be divided into modules on the same machine, which may take the form of multiple threads of execution, multiple processes, or monolithic threads/processes. Alternatively or in conjunction, certain other function elements may be split up among multiple nodes in a network, using messaging to share information among nodes.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or any other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Although the methods above are described as separate embodiments, one of skill in the art would understand that it would be possible and desirable to combine several of the above methods into a single embodiment, or to combine disparate methods into a single embodiment. For example, all of the above methods may be combined. In the scenarios where multiple embodiments are described, the methods may be combined in sequential order, in various orders as necessary.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A restaurant management system, comprising:
a management tablet computer for receiving touch-based user input;
a coordinating server for receiving an instruction from the management console and for sending a message with destination information based on the instructions;
a message queueing server, for receiving the message from the coordinating server, evaluating the destination information of the message, and forwarding the message to at least one destination, the message queueing server further comprising a plurality of messaging queues; and
a smartwatch for receiving the message from the message queueing server, the smartwatch corresponding to the destination information of the received messages.

2. The restaurant management system of claim 1, wherein the management tablet computer is an Android tablet, wherein the smartwatch is an Android Wear smartwatch.

3. The restaurant management system of claim 1, wherein the queueing server uses a queuing messaging protocol and wherein the coordinating server and the message queueing server are operated as a redundant web service.

4. The restaurant management system of claim 1, further comprising an Android tablet for receiving the message from the messaging queueing server, and a facilitation network for securely forwarding the message from the Android tablet to the smartwatch.

5. The restaurant management system of claim 1, wherein the message comprises one or more of: a notification message type; a restaurant identifier; a device identifier; human-readable text; a table number, a number of guests, allergy information, a diner special request, and information about a kitchen order.

6. The restaurant management system of claim 1, wherein the message comprises a restaurant identifier, the restaurant identifier also stored at the coordination server to authenticate and track services provided to a restaurant.

7. The restaurant management system of claim 1, wherein the message comprises a notification message type, the notification message type further comprising a food ordered message type, a food ready message type, a food ready for takeout/pickup message type, a food ready to be served message type, a table cleared message type, a table ready message type, a kitchen closing message type, a timer message type, an order changed message type, and an order canceled message type.

8. The restaurant management system of claim 1, wherein the message is configured to be dismissed, or snoozed for later action, or replied to on the smartwatch once delivered.

9. A restaurant messaging method, comprising:
receiving a restaurant management request at a coordinating server from a restaurant management device;
selecting a restaurant management function at the coordinating server based on the received restaurant management request;
identifying, at the coordinating server based on the selected restaurant management function, a targeted device to receive a notification; and
sending a notification message to a queueing server with a queue identifier based on the targeted device, to be delivered to the targeted device.

10. The restaurant messaging method of claim 9, wherein a plurality of restaurant management requests is received from a plurality of devices.

11. The restaurant messaging method of claim 9, wherein the targeted device is a wearable device or mobile device linked to an individual.

12. The restaurant messaging method of claim 9, wherein the targeted device is a smartwatch with the Android Wear operating system.

13. The restaurant messaging method of claim 9, wherein the targeted device is linked to an individual based on a prior-received mapping of individuals to either customer orders or customer restaurant tables.

14. The restaurant messaging method of claim 9, further comprising: receiving, at the queueing server, the notification message with the queue identifier at the queueing server; assigning, at the queueing server, the notification message to at least one message queue at the queueing server, the at least one message queue corresponding to the targeted device; and sending, from the queueing server, the queued message to the targeted device.

15. The restaurant messaging method of claim 9, further comprising using a facilitation network for securely forwarding the notification message to the targeted device.

16. The restaurant messaging method of claim 9, wherein the notification message comprises one or more of: a notification message type; a restaurant identifier; a device identifier; human-readable text; a table number, a number of guests, allergy information, a diner special request, and information about a kitchen order, the restaurant identifier also stored at the coordination server to authenticate and track services provided to a restaurant.

17. The restaurant messaging method of claim 9, wherein the targeted device is a mobile phone being targeted via a short message system (SMS) gateway.

18. The restaurant messaging method of claim 9, wherein the notification message comprises a notification message type, the notification message type further comprising a food ordered message type, a food ready message type, a food ready for takeout/pickup message type, a food ready to be served message type, a table cleared message type, a table ready message type, a kitchen closing message type, a timer message type, an order changed message type, and an order canceled message type.

19. The restaurant messaging method of claim 9, wherein the notification message is configured to be dismissed, or snoozed for later action, or replied to on the smartwatch once delivered.

20. A restaurant management system, comprising:
means for performing a restaurant management function based on a received restaurant management request from a restaurant management device;
means for identifying, based on the restaurant management function, a targeted device to receive a notification; and
means for delivering a notification message to the targeted device.
